(19) United States
(12) Patent Application Publication
(10) Pub. No.: US 2001/0004044 A1
(43) Pub. Date: Jun. 21, 2001

(54) Multiple switch device

(75) Inventors: Tsuyoshi Sotome, Ota-ku (JP); Osamu Furukawa, Ota-Ku (JP); Hiroshi Seki, Ota-Ku (JP); Hideo Hirai, Ota-Ku (JP)

Correspondence Address: RADER FISHMAN & GRAUER PLLC, LION BUILDING, 1233 20TH STREET N.W., SUITE 501, WASHINGTON, DC, 20036, US

(73) Assignee: Niles Part Co., Ltd.

(21) Appl. No.: 09/739,686

(22) Filed: Dec. 20, 2000

(30) Foreign Application Priority Data
Mar. 31, 2000 (JP) P2000-98202
Dec. 21, 1999 (JP) HEI 11-363474

(51) Int. Cl. H01H 9/00

(52) U.S. Cl. 200/5 R

(57) ABSTRACT

A low cost automotive power window switch having few window operating switches uses a single switch to select which of the four windows to operate, and to control the window locks. The power window switch has a window operating switch 3 for raising and lowering each of the car windows, and a mode selector switch 2 for switching between the windows. The mode selector switch 2 also has a window lock switch function for locking and unlocking the windows.

### BACKGROUND OF THE INVENTION

1. Field of the Invention

The present invention relates to a multiple switch device having a single knob used for a plurality of switching operations, and relates more particularly to improvement of a power window switch for opening and closing a plurality of windows in an automobile.

2. Description of Related Art

Power window switches conventionally used for opening and closing (referred to below as “operating”) the windows of an automobile are typically provided in the same number as there are windows to operate. This means, for example, that the power window switch panel provided at the driver's seat of a four-door vehicle has four knobs, one for operating the window of each door, a lock knob for locking the window, and a door lock knob. The resulting problem is that a large number of knobs means that the overall size of the switch panel unit is also large. This creates the further problem that the arm rest, for example, where the power window switch unit is installed grows in conjunction with the size of the power window switch unit, and thus protrudes into the passenger cabin from the side of the door.

A power window switch unit according to the related art that has been proposed to solve this problem of numerous window switches is taught in Japanese Utility Patent Laid-open Publication (kokai) 60-73141. This power window switch unit has a selection switch, which is a four-way sliding switch for selecting the window to operate, and up and down operating switches.

The problem, however, is that the selection switch of this power window switch unit according to the related art only enables the raising and lowering operation to be switched to one of four door windows, and cannot switch between more than four positions.

This is particularly a problem in, for example, a van having six windows to operate because the above-noted conventional switch cannot be used. Providing sufficient controls to operate six windows on the power window switch panel obviously requires even more knobs, a larger case, and even greater difficulty placing the panel, for example, in the arm rest.

Furthermore, a selection switch that falls in four directions protrudes greatly above the operating panel surface. The problem here is that it can therefore be easy for the driver to mistakenly touch and operate the switch.

A yet further problem is that a selection switch that falls in four directions is a joystick-like operating knob that swings in four directions. While the driver's window is the most frequently operated window, it is not the easiest to operate, and thus cannot be quickly operated in an emergency.

Furthermore, while it is also conceivable to devise a joystick switch with six operating positions, this greater number of directions in which the switch can be operated further increases the potential for mistakenly operating the wrong window or function.

### SUMMARY OF THE INVENTION

It is therefore an object of the present invention to provide a power window switch unit with few knobs and a reduced cost, having a switch used for locking and unlocking the power window switches in addition to selecting between four windows.

A further object of the present invention is to provide a multiple switch device using one knob for a plurality of switching functions, thereby reducing the number of parts and assembly steps, and reducing unit cost.

To achieve these objects, the present invention provides, in a first aspect of the present invention, a switch for operating power windows by means of window operating switches for raising and lowering a windows in a motor vehicle, and a selector switch for selecting the windows that can be operated, where the selector switch also has the functionality of a window lock switch for disabling window operation.

In this power window switch the window operating switch is preferably a single switch; and the selector switch comprises a single switch knob with a contact position for selecting the windows to operate, and a contact position for disabling power window operation.

Yet further preferably, the selector switch has a rotary switch knob, and contact positions arranged as follow: a window lock contact position for disabling window operation in the center; a driver's side contact position for operating the driver's window is right adjacent to the window lock contact position; a right rear window contact position for operating a right rear window is right adjacent to said driver's side contact position; a front passenger window contact position for operating a front passenger window is left adjacent to the window lock contact position; and a left rear window contact position for operating a left rear window is left adjacent to the front passenger window contact position.

Alternatively in a power window switch according to this first aspect of the invention the window operating switch comprises two switches disposed side by side; and the selector switch comprises a single switch knob with a switch for selecting front or back seat window operation and, when pressed, disabling window operation.

Yet further alternatively in a power window switch according to this first aspect of the invention the selector switch comprises both a rotary switch for selecting two contact positions for selecting a front seat and back seat position, and a push-button switch for disabling window operation.

Yet further alternatively in a power window switch according to this first aspect of the invention the selector switch comprises a switch movable in two directions for selecting front window operation or rear window operation, and a switch for disabling window operation.

A further switch for operating the power windows of an automobile and having a window operating switch for raising and lowering a vehicle window, and a selector switch for selecting a window to be operated by window operating switch, is characterized in another aspect of the present invention by the selector switch combining the functions of a rocker switch for moving a knob in two directions to select operation of a front seat window or rear seat window, and a push-lock switch for disabling and enabling window operation when the knob is pressed.

The selector switch in this aspect of the present invention preferably is in a contact position for operating a front seat window when the knob of selector switch is in an upright position, and is in a contact position for operating a back seat window when the knob of the selector switch is rocked to one side.

A multiple switch device for operating automobile power windows in a first row, second row, and third row according to a further aspect of the present invention has first to fourth window operating switches for operating first row, second row, and third row power windows; and a selector switch for selecting whether the third and fourth window operating switches operate the power windows of the second row or third row.

Preferably in this case the selector switch combines functions of a rocker switch for moving in two directions to select operation of a second row window or a third row window, and a push-lock switch for disabling and enabling window operation.

Yet further preferably, the selector switch is in a contact position for operating a second row window when the knob of selector switch is in an upright position, and is in a contact position for operating a third row window when the knob is rocked to one side.

A power window switch according to a further aspect of the present invention comprises a knob having protruding from the bottom thereof an operating lever for operating a switch unit, and a single operating part enabling push-action and rocker-action operations; a rocker body movably supported to a case on a pivot with operating lever of knob passing freely up and down therethrough; a case having a through-hole for operating lever passing therethrough; and a plurality of switch units operated by movement of first and second sliding studs, which engage a shaped slot formed in the operating lever of the knob.

Preferably in this power window switch the knob has a cam* on a side of operating lever; the rocker body has a lock pin for engaging the cam and a leaf spring for urging the lock pin, and forms a suitable surface contacted by a suitable body, which is urged by a suitable spring; and the case has a positioning part for placing the knob. The through-hole, a tubular protrusion forming a blind hole for holding a suitable spring, and stud hole for pivotably supporting the rocker body are formed inside the positioning part.

Yet further preferably in this power window switch, the shaped slot formed in the operating lever has a longitudinal slot in which the first sliding stud floats when the knob is pressed, a sloped slot, contiguous to the longitudinal slot, for pushing and moving the second sliding stud when the knob is pressed, and an escape slot in which second sliding stud moves freely when the knob is rocked to one side.

A multiple switch device according to a yet further aspect of the present invention comprises a switch having protruding from a bottom thereof an operating lever for operating switch units, and a rocking knob; a movable selector disposed to the operating lever of the switch for operating the two switch units. One of the switch units is operated by movement of a sliding stud engaging a first notch formed in the movable selector; and the other switch unit is operated by movement of a sliding stud engaging a second notch formed in the movable selector.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a plan view of a first preferred embodiment of the present invention;

FIG. 2 is an electrical circuit diagram of a first preferred embodiment of the present invention;

FIG. 3 is a plan view of a second preferred embodiment of the present invention;

FIG. 4 is a plan view of a third preferred embodiment of the present invention;

FIG. 5 is a partially exploded oblique view of a fourth preferred embodiment of the present invention;

FIG. 6 is a plan view of the case in a fourth preferred embodiment of the present invention;

FIG. 7 is a section view through line X-X in FIG. 6;

FIG. 8 is a section view of a knob in a fourth preferred embodiment of the present invention;

FIG. 9 is an enlarged oblique view of part the leaf spring according to an alternative version of the present invention;

FIG. 10 is an enlarged partially exploded oblique view of a switch unit in a fourth preferred embodiment of the present invention;

FIG. 11 describes a window operating switch in a fourth preferred embodiment of the present invention; and

FIG. 12 is a plan view of a fifth preferred embodiment of the present invention.

### DESCRIPTION OF THE PREFERRED EMBODIMENTS

The preferred embodiments of the present invention are described below with reference to the accompanying figures.

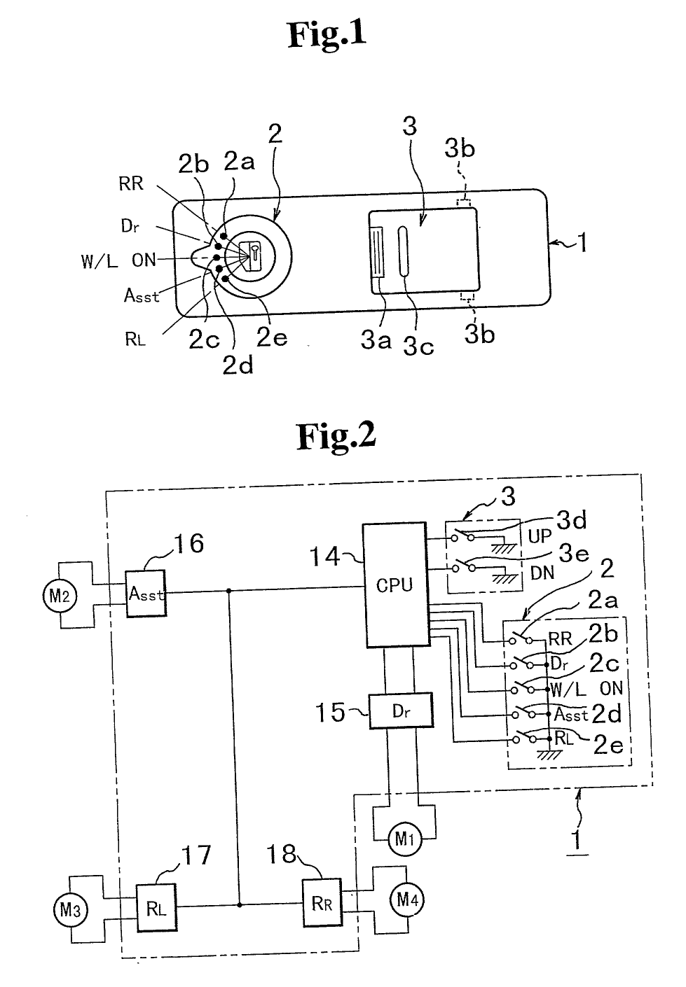

Embodiment 1 (FIG. 1 and FIG. 2)

FIG. 1 and FIG. 2 show a power window switch according to a first preferred embodiment of the present invention. This first preferred embodiment of the invention is described next below with reference to FIGS. 1 and 2.

As shown in these figures, the case 1 of an automotive power window switch has two window control switches: a mode selector switch 2, which is a combination rotary switch and push-button switch, and a window operating switch 3, which is a rocker switch for opening and closing the window. These window control switches are aligned with the front-back direction of the vehicle. The case 1 is disposed, for example, in the arm rest on the driver's side door. It should be noted that because case 1 has a small number of window control switches, case 1 can be downsized, and can thus be installed in a slimmer arm rest.

The mode selector switch 2 is a five position rotary switch with five contact positions 2a, 2b, 2c, 2d, and 2e.

In this exemplary embodiment of the invention contact position 2a (RR) is the position for operating the right rear window. Contact position 2b (Dr) is for operating the driver's window. Contact position 2c (W/L ON) is for locking the power window switches for all but the driver's window. Contact position 2d (ASST) is for operating the front passenger-side window. Contact position 2e (RL) is for operating the left rear window.

The contact positions 2a to 2e of the mode selector switch 2 are matched to the seat locations inside the cabin. Thus, the window lock contact position 2c (W/L ON) is set to the center position of mode selector switch 2. Contact position 2b (Dr) for the driver's window is set to the immediate right of contact position 2c (W/L ON); contact position 2a (RR) for the right rear window is then to the right of contact position 2b (Dr); contact position 2d (ASST) for the front passenger side window is to the immediate left of contact position 2c (W/L ON); and contact position 2e (RL) for the left rear window is to the left of contact position 2d (ASST).

By thus matching the contact positions 2a to 2e of the mode selector switch 2 to the location of seats in the vehicle, the operator does not need to look at the mode selector switch 2 to operate it, and mode selector switch 2 can thus be operated by blind touch.

The window operating switch 3 is a two-step rocker switch that can be operated by pulling up or pushing down with the switch pivoting on a stud 3b. An indicator 3c can be used for night lighting with the indicator 3c turning on when the headlights (not shown in the figure) are turned on, or it can be used as an on/off indicator with the indicator 3c turning on only when the window operating switch 3 is in the on position.

Operation of this mode selector switch 2 and window operating switch 3 is described next below with reference to the circuit diagram in FIG. 2.

Referring to FIG. 2, power window switch case 1 in which the electrical circuitry is housed is installed, for example, to the arm rest of the door. Motor M1 is built in to the driver's door, and is electrically connected to CPU 14 by way of motor controller 15. Motor controller 15 controls raising and lowering the driver's window.

Motor M2 is built in to the front passenger-side door, and is electrically connected to CPU 14 by way of motor controller 16. Motor controller 16 controls raising and lowering the passenger-side window. Motor M3 is built in to the left rear door, and is electrically connected to CPU 14 by way of motor controller 17, which controls raising and lowering the left rear window. Motor M4 is built in to the right rear door, and is electrically connected to CPU 14 by way of motor controller 18, which controls raising and lowering the right rear window.

As noted above, mode selector switch 2 has contact positions 2a to 2e. One side of each contact position 2a to 2e is connected to CPU 14, and the other is to ground. The window operating switch 3 has an up contact 3d for raising the window, and a down contact 3e for lowering the window. One side of each contact 3d and 3e is connected to CPU 14, and the other is to ground.

Thus connected, if mode selector switch 2 is set, for example, to contact position 2b (Dr) for the driver's window, and window operating switch 3 is operated to the first step in the up position, up contact 3d contacts the fixed contact for as long as the window operating switch 3 is held at this first contact position, causing motor M1 to turn and the driver's window to rise. When the window operating switch 3 is then released, the up contact 3d returns automatically to the off position, motor M1 stops, and the window stops moving.

If the window operating switch 3 is operated to the second step up, a solenoid (not shown in the figure) in the motor controller 15 holds the switch at this second contact position, or the equivalent circuit state is held electrically by means of a relay (not shown in the figure), so that up contact 3d remains in contact with the fixed contact even if released by the driver, and the driver's window rises automatically all the way closed. When the window is completely closed, the up contact 3d of window operating switch 3 returns to the off position, motor M1 stops operating, and the window stops moving.

If mode selector switch 2 is set, for example, to contact position 2b (Dr) for the driver's window, and window operating switch 3 is operated to the first step down, down contact 3e contacts the fixed contact for as long as the window operating switch 3 is held at this first contact position, causing motor M1 to reverse and the driver's window to descend. When the window operating switch 3 is then released, the down contact 3e returns automatically to the off position, motor M1 stops, and the window stops moving.

If the window operating switch 3 is operated to the second step down, a solenoid (not shown in the figure) in the motor controller 15 holds the switch at this second contact position, or the equivalent circuit state is held electrically by means of a relay (not shown in the figure), so that down contact 3e remains in contact with the fixed contact even if released by the driver, and the driver's window descends automatically all the way open. When the window is completely open, the down contact 3e of window operating switch 3 returns to the off position, motor M1 stops operating, and the window stops moving.

The other windows can also be operated as described above by setting the mode selector switch 2 to the appropriate contact position 2a, 2d, or 2e. To operate the right rear window, for example, the driver simply sets the mode selector switch 2 to contact position 2a (RR).

The driver can similarly operate the front passenger side window by setting mode selector switch 2 to contact position 2d (ASST), or can operate the left rear window by setting mode selector switch 2 to contact position 2e (RL). Furthermore, setting mode selector switch 2 to contact position 2c (W/L ON) disables the power window switch at each of the passenger windows so that the passengers cannot raise or lower the windows.

A power window switch according to this preferred embodiment of the invention thus requires uses only two window operating switches, thus reducing the number of switches and reducing cost. Furthermore, by reducing the number of switches for operating the rear windows, this first embodiment of our invention provides a power window switch that is small and which can prevent unintentional operation of a rear window power switch when attempting to operate a switch for the front windows.

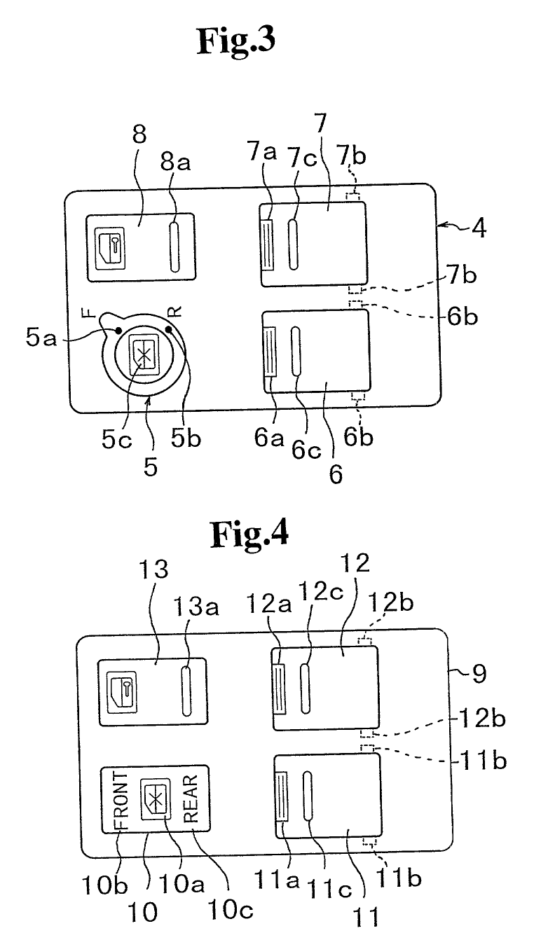

Embodiment 2 (FIG. 3)

A second preferred embodiment of an automotive power window switch according to the present invention is described next below with reference to FIG. 3.

As shown in FIG. 3, the case 4 of an automotive power window switch according to this exemplary embodiment has four window control switches: a mode selector switch 5, which is a combination rotary switch and push-button switch for selecting front or back window operation, and locking and unlocking the power window switches; a left window operating switch 6 comprising a rocker switch and the like, for operating the front or back window on the left side; a right window operating switch 7 comprising a rocker switch and the like, for operating the front or back window on the right side; and a door lock switch 8 for locking and unlocking the doors. The case 4, for example, is mounted in the arm rest on the driver's side door. The four window control switches are aligned with the front-back direction of the vehicle.

The mode selector switch 5 is, for example, a knob comprising both a rotary switch with two contact positions 5a and 5b for selecting the front or rear windows, and a push-button window lock switch that can be pressed to disable opening and closing the windows.

Contact position 5a (F) is the switch position for operating the front windows, and contact position 5b (R) is the switch position for operating the rear windows. Note that the contact positions of the mode selector switch 5 are arranged to match the vehicle so that the contact position 5a (F) for the front windows is to the front, and the rear window contact position 5b (R) is to the back. The mode selector switch 5 can thus be intuitively operated by blind touch to the desired position. Furthermore, the windows can be locked, that is, the power window switches at all non-driver window positions can be disabled, by pressing push-button 5c.

The right and left window operating switches 6 and 7 are two-step rocker switches that can be operated by pulling up or pushing down with the switch pivoting on a stud 6b, 7b, respectively. Indicators 6c, 7c, and 8a can be used for night lighting or as an on/off indicator as described above.

With a power window switch thus comprised, the driver sets the mode selector switch 5 to contact position 5a (F) and uses right window operating switch 7 to operate the right front window. If mode selector switch 5 is set to contact position 5a (F) and right window operating switch 7 is lifted to the first step, the right front window rises. When the right window operating switch 7 is released, the switch returns to the off position, the motor stops, and the window stops moving.

If the driver lifts the right window operating switch 7 to the second step, a solenoid (not shown in the figure) holds the switch at this second contact position, or the equivalent circuit state is held electrically by means of a relay (not shown in the figure), so that operation continues until the window rises all the way closed. When the window is completely closed, right window operating switch 7 returns to the off position, the motor stops, and the window stops moving.

If the driver sets the mode selector switch 5 to contact position 5b (R) and presses left window operating switch 6 down to the first step, the left rear window descends. When the switch is released, it returns to the off position, the motor stops, and the window stops moving.

If the driver presses the left window operating switch 6 down to the second step, a solenoid (not shown in the figure) holds the switch at this second contact position, or the equivalent circuit state is held electrically by means of a relay (not shown in the figure), so that operation continues until the window descends to the completely open position. When the window is completely open, left window operating switch 6 returns to the off position, the motor stops, and the window stops moving.

Pressing the door lock switch 8 locks all doors.

By thus integrating controls for the front and rear windows, a power window switch according to this second preferred embodiment of the present invention uses only four switches, thus reducing the number of controls and unit cost. Furthermore, by integrating the switches for the front and rear windows, this second preferred embodiment of the invention provides a power window switch that is small overall and can prevent such unintentional operation as operating a switch for a rear window when intending to operate one of the front windows.

It will be obvious to one with ordinary skill in the related art that the rotary switch and push-button components of the mode selector switch 5 can be separately formed and disposed. In this case, the knob for operating the mode selector switch 5 is a rotary knob with two contact positions 5a and 5b for operating the front and rear windows, and the push-button switch for the window lock switch for disabling power window switch operation is disposed inside the rotary knob.

Embodiment 3 (FIG. 4)

A third preferred embodiment an automotive power window switch according to the present invention is described next below with reference to FIG. 4.

As shown in FIG. 4, the case 9 of an automotive power window switch according to this exemplary embodiment has four window control switches: a selector switch 10, which is a combination rocker switch and push-button switch for selecting front or back window operation and controlling the window lock; a two-step left window operating switch 11 for operating the front or back window on the left side; a two-step right window operating switch 12 for operating the front or back window on the right side; and a door lock switch 13 for locking and unlocking the doors. The case 9 is mounted, for example, in the arm rest on the driver's side door. The window control switches are aligned with the front-back direction of the vehicle.

The selector switch 10 combines the functions of a rocker switch with two operating positions, and a push-button switch for the window locks. The rocker switch has a FRONT position 10b and a REAR position 10c controlling whether a front or rear window is operated. The driver depresses the push-button switch 10a in the middle of the selector switch 10 to disable the power window switches.

To operate either of the front windows, the driver sets the selector switch 10 to the front window 10b (FRONT) position. To operate the rear windows, selector switch 10 is set to the rear window 10c (REAR) position. Depressing the push-button switch 10a disables operating the windows using any power window switch other than the one at the driver's seat.

The right and left window operating switches 11 and 12 are two-step rocker switches that can be operated by pulling up or pushing down with the switch pivoting on a stud 11b, 12b, respectively. Indicators 11c, 12c, and 13a can be used for night lighting or as an on/off indicator as described above.

With a power window switch thus comprised, the driver sets the selector switch 10 to front window 10b (FRONT) and uses right window operating switch 12 to operate the right front window. If in this case right window operating switch 12 is lifted to the first step, the motor turns and the right front window rises while the switch is held at the first contact position. When the switch is released, it returns to the off position, the motor stops, and the window stops moving.

If the driver lifts the right window operating switch 12 to the second contact position, a solenoid (not shown in the figure) holds the switch at this second contact position, or the equivalent circuit state is held electrically by means of a relay (not shown in the figure), so that operation continues until the window rises all the way closed. When the window is completely closed, right window operating switch 12 returns to the off position, the motor stops, and the window stops moving.

If the selector switch 10 is set to the rear window 10c (REAR) position and the left window operating switch 11 is depressed to the first contact position, the left rear window descends and opens while the switch is held at the first contact position. When the switch is released, it returns to the off position, the motor stops, and the window stops moving.

If the driver pushes the left window operating switch 11 to the second contact position, a solenoid (not shown in the figure) holds the switch at this second contact position, or the equivalent circuit state is held electrically by means of a relay (not shown in the figure), so that operation continues until the window is completely open. When the window is completely open, left window operating switch 11 returns to the off position, the motor stops, and the window stops moving.

Pressing the door lock switch 13 locks all doors.

A power window switch according to this preferred embodiment of the invention uses only four control switches as described above, thus reducing the number of controls and reducing unit cost. Furthermore, by integrating the switches for the front and rear windows, this third preferred embodiment of the invention provides a power window switch that is small overall and can prevent such unintentional operation as operating a switch for a rear window when intending to operate one of the front windows.

It will be obvious to one with ordinary skill in the related art that the selector switch 10 can be alternatively comprised using a three position (front, back, and center) rocker switch. The selector switch 10 in this case preferably has two contact positions for selecting the front or rear windows when the switch should be moved toward front or rear, i.e., a front window 10b (FRONT) position and a rear window 10c (REAR) position, and a window lock contact position in the center for disabling power window switch operation as previously described.

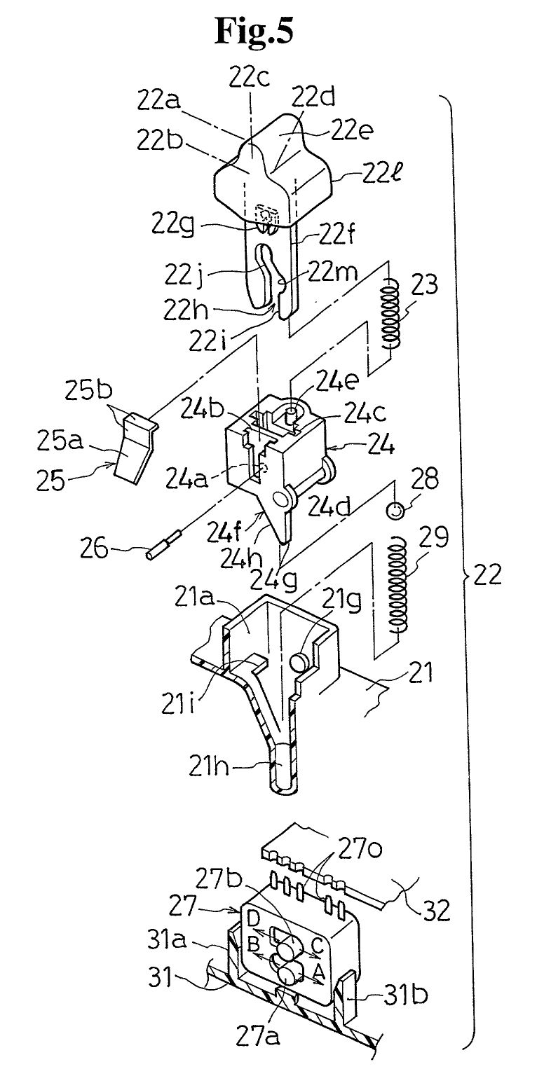

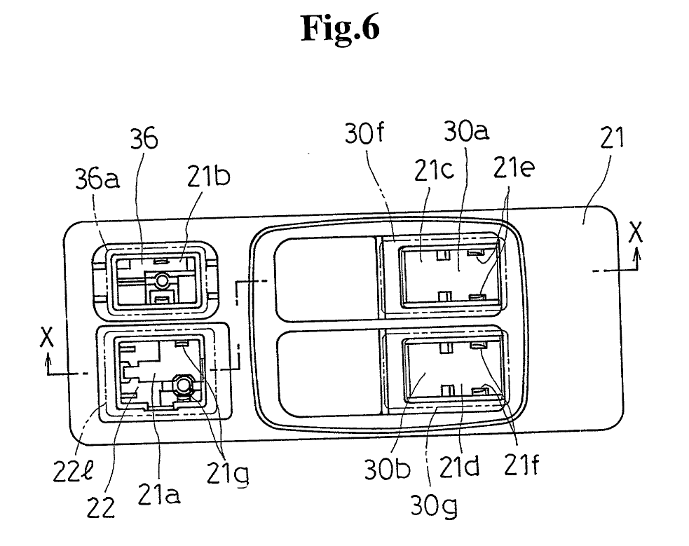

Embodiment 4 (FIGS. 5 to 11)

A fourth preferred embodiment of the present invention is described next below with reference to FIG. 5 to FIG. 11. This fourth preferred embodiment of the invention is described with reference to a automotive power window switch for operating four door windows.

The case 21 of this automotive power window switch has a first control location 21a in which a knob 22l, for example, is mounted, a second control location 21b, third control location 21c, and fourth control location 21d. The case 21 is mounted, for example, in the arm rest on the driver's side door.

Rocker body 24 and operating lever 22f of selector switch 22 are installed to first control location 21a. Note that the selector switch 22, further described below, combines the functions of a push-lock switch and a rocker switch. Inside first control location 21a are formed: a stud 21g for supporting rocker body 24; through-hole 21i for passing operating lever 22f so that operating lever 22f can rock freely; and spring hole 21h, which is a blind hole for holding a suitable spring 29. Note that the spring hole 21h is a cylindrical protrusion to which suitable spring 29 is inserted.

Selector switch 22 also functions as a window lock switch for locking and unlocking the windows by pressing knob 22l. By rocking knob 22l, selector switch 22 is also used to switch operation of the first window operating switch 30a and the second window operating switch 30b between raising and lowering the front driver and passenger windows, or the rear right and left windows.

A door lock switch 36, which is typically a rocker switch, is located at the second control location 21b. The function of this door lock switch 36 is to lock and unlock the doors in response to the rocking operation of knob 36a.

The first window operating switch 30a, which is a two-step rocker switch, is located at the third control location 21c. When knob 30f of first window operating switch 30a is pushed to a first contact position, the driver's side or right rear window can be manually lowered (opened). When knob 30f is further depressed to a second contact position, the driver's side or right rear window can be automatically lowered to the fully open position.

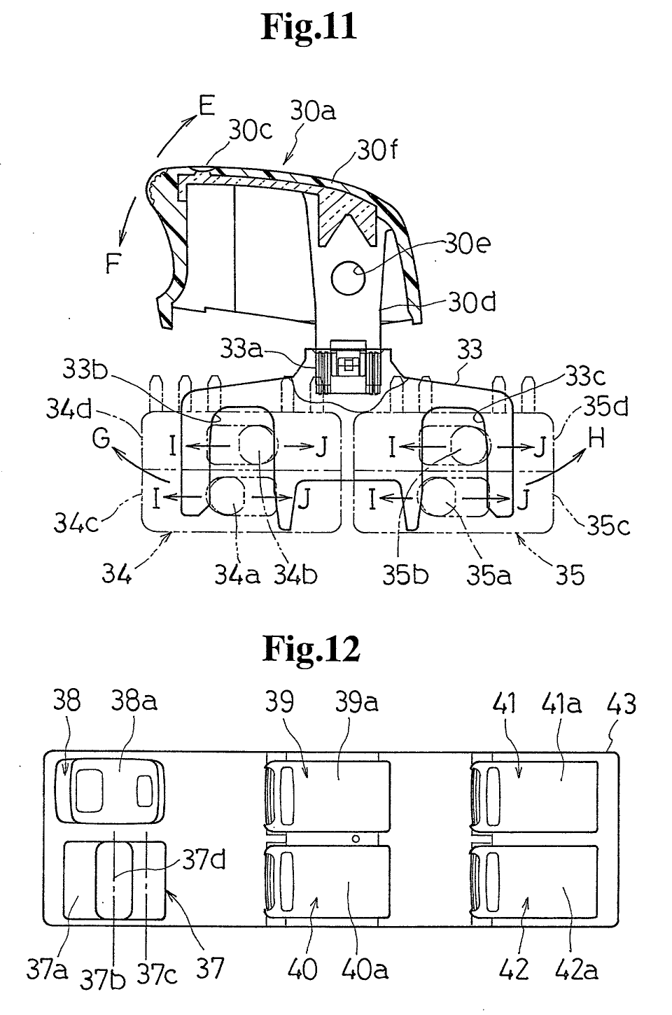

The first and second window operating switches 30a, 30b rock on studs 21e, 21f when the respective knob 30f, 30g is raised or lowered as shown in FIG. 11. The first and second window operating switches 30a, 30b have two operating positions (steps) in both directions (up and down).

Lifting the first window operating switch 30a to the first operating (step) position allows the operator to manually raise the driver or right rear window. Lifting the knob 30f of first window operating switch 30a further to the second operating position accesses an automatic mode in which the driver or right rear window is raised automatically to the fully closed position.

The second window operating switch 30b, which is a two-step rocker switch having a knob 30g, is located at the fourth control location 21d. When knob 30g of second window operating switch 30b is pushed to a first operating position (step), the passenger side or left rear window can be manually lowered (opened). When knob 30g is further depressed to a second operating position, the passenger side or left rear window can be automatically lowered to the fully open position.

The second window operating switch 30b has a function for manually rasing the passenger side or left rear window as a result of knob 30g being lifted to the first operating position. It also has a function for automatically raising the passenger side or left rear window all the way closed when the knob 30g is further lifted to a second operating position.

It will be obvious to one with ordinary skill in the related art that case 21 can be made smaller overall, and the arm rest in which case 21 is installed can therefore be made slimmer, because the number of window operating switches is smaller than in a conventional automotive power window switch. In addition, the first window operating switches 30a and 30b are also arranged in the case 21 to match the locations of the windows in the vehicle.

When the knob 22l of selector switch 22 is in the up position as shown in FIG. 5, selector switch 22 is in contact position 22a, that is, the position for unlocking window operation. When the knob 22l is pressed to the down position, selector switch 22 is in contact position 22b for locking window operation.

When knob 22l of selector switch 22 is in the center neutral position (pointing straight up), the selector switch 22 is at contact position 22c, that is, the front driver and passenger side windows can be operated using first and second window operating switches 30a and 30b. When selector switch 22 is at this contact position 22c, the rear windows cannot be operated.

When knob 22l of selector switch 22 is rocked from contact position 22c, the selector switch 22 is at contact position 22d enabling the left and right rear windows to be operated using first and second window operating switches 30a and 30b. When selector switch 22 is at this contact position 22d, the front windows cannot be operated.

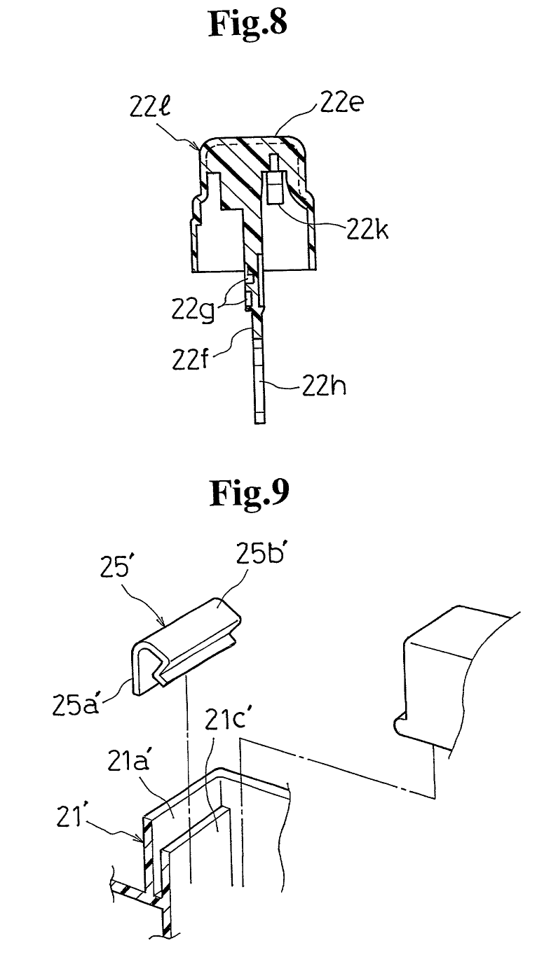

The knob 22l of selector switch 22 is molded to integrate the top button head 22e and operating lever 22f therebelow as shown in FIG. 8. The operating lever 22f has a shaped slot 22h and a push-lock cam 22g. The selector switch 22 is inserted to rocker body 24 so that it can move freely up and down by way of return spring 23, which automatically returns knob 22l.

The operating lever 22f passes through-hole 24c in rocker body 24 so that shaped slot 22h engages first and second sliding studs 27a and 27b of switch unit 27. By engaging hole 24d with stud 21g of first control position 21a in case 21, rocker body 24 rocks around stud 21g in conjunction with knob 22l.

Shaped slot 22h has a longitudinal slot 22i for engaging first sliding stud 27a of switch unit 27 at the end, and a sloped slot 22j contiguous to longitudinal slot 22i for engaging second sliding stud 27b of switch unit 27. This first sliding stud 27a floats inside longitudinal slot 22i when knob 22l is pressed. When knob 22l is pressed, sloped slot 22j pushes on second sliding stud 27b, causing it to move. An escape slot 22m allowing second sliding stud 27b to float when knob 22l is rocked is formed at the junction between longitudinal slot 22i and sloped slot 22j.

Return spring 23 is a coil spring that urges upward on knob 22l so that cam 22g contacts lock pin 26 and holds selector switch 22 in the on or off position. The top end of return spring 23 fits onto spring mount 22k shown in FIG. 8, and the bottom end fits onto spring mount 24e shown in FIG. 5. Spring mounts 22K, and 24e each have a protrusion that fits loosely into an end of return spring 23, which is a coil spring as noted above, and an annual groove. Spring mount 22k is formed juxtaposed to operating lever 22f, which is formed in the middle of selector switch 22 knob 22l. spring mount 24e is formed juxtaposed to through-hole 24c formed in the middle of rocker body 24.

Cam 22g is formed integrally to the side of operating lever 22f, or is formed as a separate part that is then bonded in place. Leaf spring 25 applies constant pressure to lock pin 26, the end of which is thus held in contact with the cam 22g, and holds selector switch 22 in the on or off position.

Lock pin 26, which is thus pressed against cam 22g, is a metal rod. Lock pin 26 passes through lateral hole 24a in rocker body 24 with one end of lock pin 26 contacting leaf spring 25 pressed to cam 22g.

The leaf spring 25 urging lock pin 26 has a spring part 25a that is flexible and pushes on lock pin 26, and a mounting part 25b for mounting leaf spring 25 to the rocker body 24. The spring part 25a of leaf spring 25 is inserted to and held in longitudinal hole 24b formed in rocker body 24.

It should be noted that the leaf spring 25 shown in FIG. 5 can be alternatively comprised as leaf spring 25′ with a mounting part 25b′ as shown in FIG. 9. The mounting part 25b′ in this case is a flexible part that is press fit to leaf 21c′, which is inset to first control location 21a′ of case 21′, to secure leaf spring 25′. Note that this mounting part 25b′ is a flexible piece that covers and clamps on leaf 21c′.

Hole 24d formed in both sides of rocker body 24 is engaged with stud 21g of case 21, thus rockably supporting the rocker body 24 with a suitable body 28 urged by a suitable spring 29 pushing on a suitable protrusion 24f formed on the bottom of the rocker body 24. The rocker body 24 is held with the knob 22l of selector switch 22 in the vertical contact position 22c as a result of body 28 pushing on incline 24g of protrusion 24f. Furthermore, protrusion 24f is also held with knob 22l at the rocked contact position 22d as a result of body 28 pushing on incline 24h.

Suitable spring 29 is inserted and held in spring hole 21h formed inside first control location 21a of selector switch 22.

As shown in FIG. 5, switch unit 27 is held with the bottom thereof fit between support fingers 31a and 31b, which are formed protruding from the base 31. The plural contacts 27c protruding at the top of switch unit 27 are inserted to through-holes 32a in substrate 32 and soldered in place.

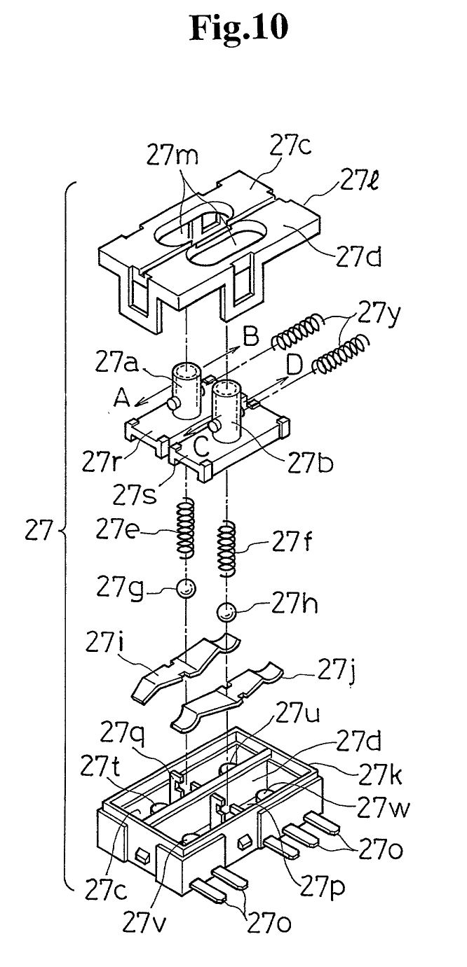

FIG. 10 is a partially exploded view of switch unit 27 according to this preferred embodiment of the invention. This switch unit 27 has a selector switch part 27c, and a window lock switch part 27d for locking and unlocking the windows. The selector switch part 27c is for switching the knob 22l of selector switch 22 between a front seat window position for operating the front windows, and a rear seat window position for operating the rear windows.

The first and second sliding studs 27a and 27b are tubular members to which contact springs 27e, 27f and steel balls 27g, 27h are inserted and held. A flat sliding base 27r, 27s is integrally formed to first and second sliding studs 27a, 27b. The end of first and second sliding studs 27a, 27b passes through elliptical hole 27m in cover piece 27l. The first and second sliding studs 27a, 27b engage shaped slot 22h of operating lever 22f, and the side of each stud is pushed by a return spring 27y. Each contact spring 27e, 27f pushes on contact plate 27i, 27j by way of intervening steel ball 27g, 27h. One end of each return spring 27y engages first and second sliding studs 27a, 27b, and the other end pushes against the inside wall of switch case 27k.

Each contact plate 27i, 27j is rockably supported by engaging the longitudinal center thereof with the U-shaped notch in common contacts 27p, 27q. The switch case 27k which cover piece 27l engages is insert molded to form common contacts 27p, 27q, fixed contacts 27t, 27u, 27v, and 27w, and contacts 27o. The contact plates 27i, 27j contact the fixed contacts 27t, 27u, 27v, and 27w. It should be noted that fixed contact 27v is the contact contacted by contact plate 27j when selector switch 22 window lock switch part 27d is in the off position, and can be omitted.

The cover piece 27l holds first and second sliding studs 27a, 27b urged in contact with contact spring 27e, 27f, and closes the opening to switch case 27k.

When the knob of selector switch 22 is raised in contact position 22a, second sliding stud 27b is at the bottom end of sloped slot 22j, moved in the direction of arrow C in FIG. 5 and FIG. 10 with the window lock switch part 27d in the off position. The first sliding stud 27a at this time is positioned at the bottom end of longitudinal slot 22i in operating lever 22f.

When knob 22l of selector switch 22 is then depressed, window lock switch part 27d switches to the on position at contact position 22b. When knob 22l of selector switch 22 descends, second sliding stud 27b is pushed into sloped slot 22j, and moves in the direction of arrow D. Contact plate 27j then rocks on common contact 27p to the opposite side, and window lock switch part 27d switches to the on position. At this time first sliding stud 27a is at the top end of longitudinal slot 22i in operating lever 22f.

When selector switch 22 knob 22l is in the vertical position at contact position 22c, first sliding stud 27a is at the front seat contact position 22c, enabling operation of the front windows, moved in the direction of arrow A in FIG. 5 and FIG. 10.

When selector switch 22 knob 22l rocks to the back seat contact position 22d, the windows that can be operated by first and second window operating switches 30a and 30b change to the rear seat windows. When selector switch 22 knob 22l then rocks to the second contact position 22d, first sliding stud 27a is pushed by the edge of longitudinal slot 22i and moves in the direction of arrow B. Contact plate 27i then rocks to the opposite side on common contact 27q, which rockably supports contact plate 27i, and selector switch part (contacts) 27c changes to the rear seat position. Second sliding stud 27b at this time floats freely in sloped slot 22j.

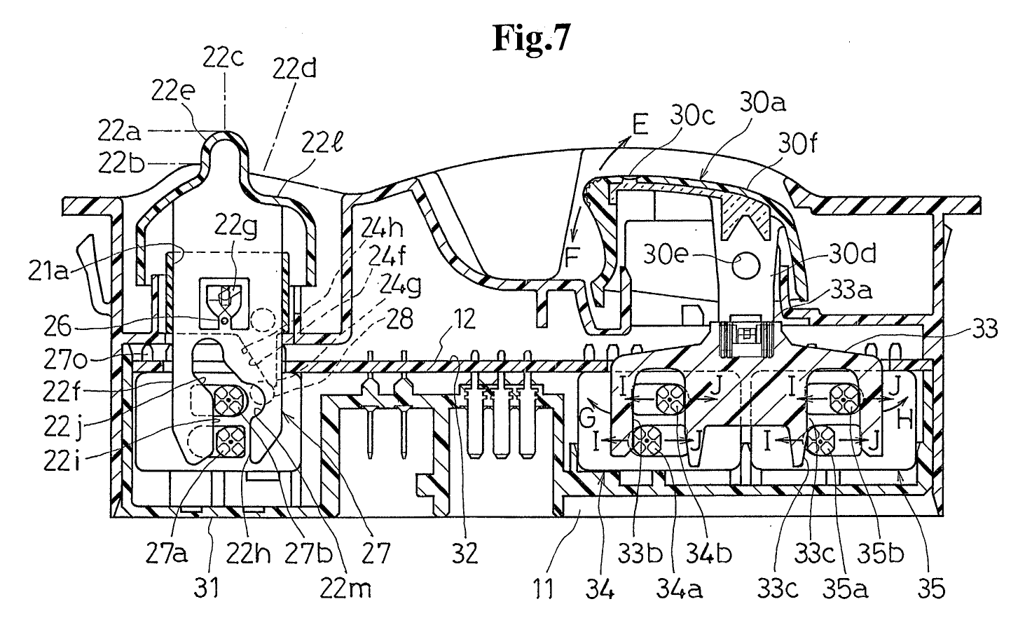

The construction of first and second window operating switches 30a and 30b is described in detail next below with reference to FIG. 7 and FIG. 11. It should be noted that first and second window operating switches 30a and 30b are identical in construction, and the following description therefore refers to the first window operating switch 30a only.

First window operating switch 30a has an operating lever 30d integrally connected to movable selector 33, and is rockably supported on case 21 by engaging stud 21f in hole 30e. An indicator (not shown in the figure) for illuminating lighting indicator 30c is disposed inside knob 30f of first window operating switch 30a. This lighting indicator 30c is formed by overlaying a photoconductor inside the opaque knob 30f. The end 30 of operating lever 30d is fit onto connector 33a of movable selector 33. As a result, movable selector 33 rocks around hole 30e in conjunction with knob 30f of first window operating switch 30a.

The movable selector 33 has a first notch 33b and second notch 33c for respectively engaging the sliding studs 34a, 34b, 35a, 35b of the front seat switch unit 34 and rear seat switch unit 35, which are disposed in line with each other.

The front seat switch unit 34 and rear seat switch unit 35 are switches substantially identical in structure to the switch unit 27 described above. The front and rear seat switch units 34, 35 are positioned before and after the operating lever 30d, the bottom side thereof fit to base 31 and the top fixed to substrate 32 similarly to switch unit 27.

The return spring (not shown in the figure) disposed inside front and rear seat switch units 34, 35 is also used to automatically return the knob 30f, 30g of first and second window operating switches 30a and 30b to the off position. It should be noted that disposing a return spring to both sides of sliding studs 34a, 34b, 35a, 35b is sufficient to increase the operating force of first and second window operating switches 30a and 30b as desired.

Front and rear seat switch units 34, 35 each have two parts: forward switch part 34c, 35c where sliding stud 34a, 35a operates to lower the window, and reverse switch part 34d, 35d where sliding stud 34b, 35b operates to raise the window. For example, if knob 30f of first window operating switch 30a is lifted in the direction of arrow E, movable selector 33 rotates in the direction of arrow G around hole 30e. Guided by movable selector 33, sliding studs 34a, 34b, 35a, 35b of front and rear seat switch units 34, 35 move in the direction of arrow I, forward switch part 34c, 35c turns on, and the window rises.

It should be noted that if selector switch 22 knob 22l is in the front seat contact position 22c at this time, the rising window will be the driver's window because only the front seat switch unit 34 operates at this time. Likewise, if the selector switch 22 knob 22l is in the rear seat contact position 22d, only the rear seat switch unit 35 operates and the right rear window thus rises.

If knob 30f of first window operating switch 30a is pushed in the direction of arrow F, movable selector 33 rotates pivoting on hole 30e in the direction of arrow H. In this case, sliding studs 34a, 34b, 35a, 35b of front and rear seat switch units 34, 35 move in the direction of arrow J guided by movable selector 33, reverse switch part 34d, 35d turns on and the window descends.

It should be noted that if selector switch 22 knob 22l is in the front seat contact position 22c at this time, the descending window will be the driver's window because only the front seat switch unit 34 operates at this time. Likewise, if the selector switch 22 knob 22l is in the rear seat contact position 22d, only the rear seat switch unit 35 operates and the right rear window thus opens.

Thus comprised, a power window switch according to this fourth preferred embodiment of the present invention operates as described below.

For example, if mode selector switch 22 is operated so that knob 22l is in the vertical position at contact position 22c, first window operating switch 30a switches to the controller for operating the driver's side windows, and second window operating switch 30b switches to the controller for operating the passenger's side windows. Then, if the knob 30f of the first window operating switch 30a is lifted to the first operating position (step), the movable contact for raising (closing) the window contacts the fixed contact for as long as knob 30f of first window operating switch 30a is held in this first operating position. The motor thus turns and the driver's side window rises. When the knob 30f of first window operating switch 30a is released, the movable contact for raising the window returns automatically to the off position, the motor stops, and the window stops moving.

If the knob 30f of first window operating switch 30a is lifted further to the second operating position (step), a solenoid (not shown in the figure) in the motor controller holds the switch at this second operating position, or the equivalent circuit state is held electrically by means of a relay (not shown in the figure), so that the window-raising movable contact remains in contact with the fixed contact. Operation thus continues until the driver's window rises all the way closed. When the window is completely closed, window-raising movable contact returns to the off position, the motor stops, and the window stops moving.

If selector switch 22 knob 22l remains in the front seat contact position 22c and knob 30f of first window operating switch 30a is pushed down to the first operating position, the movable contact for lowering (opening) the window contacts the fixed contact for as long as knob 30f of first window operating switch 30a is held in this first operating position. The motor thus reverses and the driver's side window descends. When the knob 30f of first window operating switch 30a is released, the movable contact for lowering the window returns automatically to the off position, the motor stops, and the window stops moving.

If the knob 30f of first window operating switch 30a is pushed further to the second operating position (step), a solenoid (not shown in the figure) in the motor controller holds the switch at this second operating position, or the equivalent circuit state is held electrically by means of a relay (not shown in the figure), so that the window-lowering movable contact remains in contact with the fixed contact. Operation thus continues until the driver's window descends all the way open. When the window is completely open, window-lowering movable contact returns to the off position, the motor stops, and the window stops moving.

If the selector switch 22 knob 22l is moved to the rear seat contact position 22d, the first window operating switch 30a operates in the same way to control the right rear window, and second window operating switch 30b operates in the same way to control the left rear window.

If selector switch 22 knob 22l is pressed from contact position 22a to contact position 22b, the power window switches at all seats other than the driver's seat are disabled so that the windows cannot be operated.

The number of control knobs is reduced and cost is thus reduced in a power window switch according to this preferred embodiment of the present invention by combining push-lock switch and rocker switch functions in a single selector switch 22, which is then used for switching the operating mode of the first and second window operating switches 30a and 30b of the power window switch between the front and back seat windows, and controlling a window lock function.

Furthermore, by eliminating dedicated switches for operating the rear windows, this fourth preferred embodiment of the invention provides a power window switch that is small overall and can prevent such unintentional operation as operating a switch for a rear window when intending to operate one of the front windows.

Embodiment 5 (FIG. 12)

A power window switch according to a fifth exemplary embodiment of the present invention is described next below with reference to FIG. 12.

An automotive power window switch according to this fifth embodiment of the invention is directed to providing a compact power window switch unit for a van or other type of vehicle having up to six windows in three rows.

It should be noted that selector switch 37 according to this fifth exemplary embodiment is identical to the selector switch 22 of the fourth embodiment described above, and differs only in that contact position 22c of knob 37a is the contact position for windows in the second row, and contact position 22d of Knob 37a is the contact position for windows in the third row.

In addition, door lock switch 38 is identical in application and construction to the door lock switch 36 of the fourth preferred embodiment. Yet further, the first window operating switch 39, second window operating switch 40, third window operating switch 41, and fourth window operating switch 42 are also identical in application and construction to the first and second window operating switches 30a and 30b of the fourth preferred embodiment.

The selector switch 37 comprises the functions of a rocker switch having a knob 37a that rocks between two in-line contact positions, and a push-button used for a window lock function. More specifically, the knob 37a rocks between a second row contact position 37b for operating windows in the second row, and a third row contact position 37c for operating windows in the third row. The push-button 37d located in the middle of knob 37a is depressed to lock the windows so that they cannot be opened and closed.

Referring to FIG. 12, case 43 of this automotive power window switch is populated with six knobs 37a, 38a, 39a, 40a, 41a, 42a for the selector switch 37, door lock switch 38, and first to four window operating switches 39, 40, 41, 42, respectively. This case 43 is mounted in the driver's side arm rest, for example. The four window operating switches 39, 40, 41, 42 are positioned in correlation to the front-back direction of the vehicle and the first to third rows.

Using both a rocker switch and push-button switch, the selector switch 37 is a combination row selector and window lock switch. The door lock switch 38 locks and unlocks the door locks. The first window operating switch 39 is a dedicated switch for controlling the driver's window, and second window operating switch 40 is a dedicated switch for controlling the front seat passenger window. The first window operating switch 39 can be operated by lifting up or pushing down on the knob as described in the previous embodiments, and enables two-step operation in both directions. The third and fourth window operating switches 41, 42 have one switch unit disposed to the operating level as in a conventional power window switch.

The third window operating switch 41 is for operating the right window in the second or third row. The fourth window operating switch 42 is for operating the left window in the second or third row. A movable selector for operating two switch units as described in the fourth exemplary embodiment above is further linked to the operating lever of the third and fourth window operating switches 41, 42. That is, the switch units are constructed as shown in FIG. 11 with the front seat switch unit 34 shown in FIG. 11 being used as the switch unit for the second row, and the rear seat switch unit 35 being used as the switch unit for the third row.

For example, if knob 37a of selector switch 37 is set to the second row contact position 37b and knob 42a of fourth window operating switch 42 for operating the left-side window is lifted up to the first operating position, the window motor turns and the left window in the second row rises for as long as knob 41a is held down. When knob 42a is released, the switch returns automatically to the off position, the motor stops, and the window stops moving.

If knob 37a of selector switch 37 is set to the third row contact position 37c and knob 41a of third window operating switch 41 for operating the right side window is pushed down, the right side window in the third row opens for as long as knob 41a is held down. When the knob 41a is released, the switch returns automatically to the off position, the motor stops, and the window stops.

Depressing knob 38a of door lock switch 38 locks all doors.

It will thus be obvious that a power window switch according to this fifth exemplary embodiment of the invention uses five knobs 37a, 39a, 40a, 41a, 42a, including selector switch 37 that also operates as a window lock switch, to operate six windows, thus reducing the number of window operating switches and reducing cost. Furthermore, by integrating the switches used to control windows in the second and third rows, this fifth exemplary embodiment of the invention provides a power window switch that is small overall.

[Effects of the invention]

Thus comprised, a power window switch according to the present invention provides the following benefits and effects.

A power window switch according to a first aspect of the present invention has a switch for operating power windows by means of window operating switches for raising and lowering a windows in a motor vehicle, and a selector switch for selecting the windows that can be operated, where the selector switch also has the functionality of a window lock switch for disabling window operation. As a result, the present invention provides a small, low cost power window switch with few window operating switches without impairing power window switch functionality. It is therefore also possible to reduce the overall length and width of the power window switch unit, which can thus be easily installed to the desired location.

In this power window switch the window operating switch is preferably a single switch; and the selector switch comprises a single switch knob with a contact position for selecting the windows to operate, and a contact position for disabling power window operation. Thus comprised, the present invention can provide a power window switch that uses only two switches to raise and lower each of the four windows (right and left, front and back), as well as lock and unlock the windows and door locks. By thus reducing the six window operating switches of a conventional power window switch device to only two, the power window switch can be downsized, the arm rest to which it is installed can be slim, and the distance that the arm rest projects from the door into the cabin can be reduced. The passenger cabin can thus be made more comfortable. Furthermore, by reducing the number of window operating switches, the number of parts and the number of assembly steps can be greatly reduced, thus enabling cost reduction.

Yet further preferably, the selector switch has a rotary switch knob, and contact positions arranged as follow: a window lock contact position for disabling window operation in the center; a driver's side contact position for operating the driver's window is right adjacent to the window lock contact position; a right rear window contact position for operating a right rear window is right adjacent to said driver's side contact position; a front passenger window contact position (2d) for operating a front passenger window is left adjacent to the window lock contact position; and a left rear window contact position for operating a left rear window is left adjacent to the front passenger window contact position. The contact positions of the mode selector switch can thus be matched to the location of particular seats (windows) in the vehicle. Operating the window operating switches by blind touch is thus possible, and a power window switch that is easy to operate can be provided.

Alternatively in a power window switch according to this first aspect of the invention the window operating switch comprises two switches disposed side by side; and the selector switch comprises a single switch knob with a switch for selecting front or back seat window operation and, when pressed, disabling window operation. It is thus possible to provide a power window switch in which two window operating switches are used to control operating the four windows (right and left, front and back), and one window operating switch for locking and unlocking the power windows and selecting the windows to be operated by the other two window operating switches. It is thus possible to reduce the number of parts and the number of assembly steps, reduce the cost, and provide an overall small switch unit without eliminating any switch functionality.

Yet further alternatively in a power window switch according to this first aspect of the invention the selector switch comprises both a rotary switch for selecting two contact positions for selecting a front seat and back seat position, and a push-button switch for disabling window operation.

It is therefore possible to provide a power window switch that can lock and unlock the power windows, and select the power windows to operate, using only one rotary window operating switch. It is thus possible to reduce the number of parts and the number of assembly steps, and reduce the cost, without eliminating any switch functionality.

Yet further alternatively in a power window switch according to this first aspect of the invention the selector switch comprises a switch movable in two directions for selecting front window operation or rear window operation, and a switch for disabling window operation. It is therefore possible to provide a power window switch that can lock and unlock the power windows, and select the power windows to operate, using only one rocker type window operating switch. It is thus possible to reduce the number of parts and the number of assembly steps, and reduce the cost, without eliminating any switch functionality.

A further switch for operating the power windows of an automobile and having a window operating switch for raising and lowering a vehicle window, and a selector switch for selecting a window to be operated by window operating switch, is characterized in another aspect of the present invention by the selector switch combining the functions of a rocker switch for moving a knob in two directions to select operation of a front seat window or rear seat window, and a push-lock switch for disabling and enabling window operation when the knob is pressed. It is therefore possible to provide a compact, low cost power window switch having a small number of window operating switches.

The selector switch in this aspect of the present invention preferably is in a contact position for operating a front seat window when the knob of selector switch is in an upright position, and is in a contact position for operating a back seat window when the knob of the selector switch is rocked to one side. It is therefore possible to provide a power window switch wherein knob operation is easy when the knob of the selector switch is in the contact position for operating a first window operating switch, which is the most frequently used front seat window.

A multiple switch device for operating automobile power windows in a first row, second row, and third row according to a further aspect of the present invention has first to fourth window operating switches for operating first row, second row, and third row power windows; and a selector switch for selecting whether the third and fourth window operating switches operate the power windows of the second row or third row. It is thus possible to operate windows in a first, second, and third row using fewer knobs than there are windows. It is therefore possible to provide a power window switch ideally suited for use in vans and other types of vehicles having six power windows. Furthermore, by providing first and second window operating switches used for operating the windows in the first row, that is, the windows in the driver's seat row that are used most frequently and which must on occasion be immediately operable, independently so that they can be operated without first being selected, the windows in the first row can always be immediately operated. An overall compact switch unit having fewer switch knobs than windows can thus be provided without impairing driving safety.

Preferably in this case the selector switch combines functions of a rocker switch for moving in two directions to select operation of a second row window or a third row window, and a push-lock switch for disabling and enabling window operation. By thus using independent dedicated switches to operate the most frequently used first row windows, and enabling the window operating switches for the relatively less frequently used second and third row windows to be appropriately selected using a switch combining the functions of a rocker switch and push-button switch, the number of switch knobs on the power window switch unit can be reduced, the overall power window switch unit size can be reduced for easy installation in a suitable narrow space such as an arm rest, and cost can be reduced.

Yet further preferably, the selector switch is in a contact position for operating a second row window when the knob of selector switch is in an upright position, and is in a contact position for operating a third row window when the knob is rocked to one side. By thus enabling operation of the window lock switch at the same contact position used for operating the second row windows, which are used more frequently than the third row windows, the window lock switch can be easily operated at the most frequent contact position.

A power window switch according to a further aspect of the present invention comprises a knob having protruding from the bottom thereof an operating lever for operating a switch unit, and a single operating part enabling push-action and rocker-action operations; a rocker body movably supported to a case on a pivot with operating lever of knob passing freely up and down therethrough; a case having a through-hole for operating lever passing therethrough; and a plurality of switch units operated by movement of first and second sliding studs, which engage a shaped slot formed in the operating lever of the knob. It is thus possible to provide a multiple switch device enabling both push-button switch and rocker switch operations with a single switch unit. It is therefore possible to reduce the number of switch units, reduce the number of parts and assembly steps, and reduce cost, thus downsizing the overall switching device so that it can be easily installed in a suitable place. Furthermore, a multifunction switch combines the functions of a rocker switch that rocks to a desired contact position in conjunction with the switch (rocker) body, and a push-lock switch. One switch can thus be used for two purposes. Accidental operation can also be prevented by using two different switch operations, that is, a rocker switch operation and push-button operation, for the two purposes for which the two-function switch is used.

Preferably in this power window switch the knob has a cam on a side of operating lever; the rocker body has a lock pin for engaging the cam and a leaf spring for urging the lock pin, and forms a suitable surface contacted by a suitable body, which is urged by a suitable spring; and the case has a positioning part for placing the knob. The through-hole, a substantially tubular protrusion forming a blind hole for holding the suitable spring, and stud hole for pivotably supporting the rocker body are formed inside the positioning part. In this case a single switch can be used for two switch operations, that is, a rocker switch operation and push-button operation, one switch can be used for a plurality of purposes, and the number of operation knobs on the switch device can be reduced, thereby simplifying the switch device. In addition, by making the blind hole substantially a cylindrical shape and placing a suitable spring and a suitable body inside the positioning part pivotably supporting the rocker body, parts around the blind hole in the case thicker than the depth of the blind hole, and the positioning part, can be plastically molded using a thin-wall material. The amount and cost of the resin material used for molding the case can thus be reduced, reducing overall cost. Furthermore, by placing the lock pin and spring conventionally disposed to the case in the rocker body, it is not necessary to install the lock pin to the case, the thickness of the case around the rocker body can be reduced, and overall switch weight can be reduced.

Yet further preferably in this power window switch, the shaped slot formed in the operating lever has a longitudinal slot in which the first sliding stud floats when the knob is pressed, a sloped slot, contiguous to the longitudinal slot, for pushing and moving the second sliding stud when the knob is pressed, and an escape slot in which second sliding stud moves freely when the knob is rocked. The second sliding stud engaged with the shaped slot in the depressed knob is thus allowed to move freely when the knob is further rocked to another contact position so that the push-lock switch can be held in the on state by the second sliding stud while the knob is rocked to turn the rocker switch on. Furthermore, by providing contiguously a longitudinal slot, inclined slot, and escape slot in the operating lever of the knob, and engaging the first and second sliding studs of the switch unit with this contiguous slot, the push-button and rocker operations of the knob can be reliably relayed. Further, when the knob is depressed and then further rocked to a rocker switch contact position, the second sliding stud will not catch in the slot, and a multiple switch device that can be easily and comfortably operated can be provided.

A multiple switch device according to a yet further aspect of the present invention comprises a switch having protruding from a bottom thereof an operating lever for operating switch units, and a rocking knob; a movable selector disposed to the operating lever of the switch for operating the two switch units. One of the switch units is operated by movement of a sliding stud engaging a first notch formed in the movable selector; and the other switch unit is operated by movement of a sliding stud engaging a second notch formed in the movable selector. A multiple switch device thus comprised enables one window operating switch to simultaneously operate a plurality of switch units. In addition, the number of switches, and therefore cost, can be reduced, the number of knobs is reduced to enable using a smaller case, and the multiple switch device can be easily installed in a suitable location.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A multiple switch device for operating a power window and having a window operating switch (3, 6, 7, 11, 12, 30a, 30b, 39, 40, 41, 42) for raising and lowering a vehicle window, and a selector switch (2, 5, 10, 22, 37) for selecting a particular window for operation, said multiple switch device characterized by the selector switch (2, 5, 10, 22, 37) also having a lock switch function for disabling window operation.

2. A multiple switch device as described in claim 1, wherein:
said window operating switch (3) is a single switch; and
said selector switch (2) comprises one switch knob with a contact position (2a, 2b, 2d, 2e) for selecting each window to operate, and a contact position (2c) for disabling window operation.

3. A multiple switch device as described in claim 2, wherein:
said selector switch (2) has a rotary switch knob, and contact positions (2a, 2b, 2c, 2d, 2e) are arranged as follow:
a window lock contact position (2c) for disabling window operation is a center position;
a driver's side contact position (2b) for driver's window operation is right adjacent to said window lock contact position (2c);
a right rear window contact position (2a) for operating a right rear window is right adjacent to said driver's side contact position (2b);
a front passenger window contact position (2d) for operating a front passenger window is left adjacent to the window lock contact position (2c); and
a left rear window contact position (2e) for operating a left rear window is left adjacent to the front passenger window contact position (2d).

4. A multiple switch device as described in claim 1, wherein:
said window operating switch (6, 7, 11, 12) comprises two switches disposed side by side; and
said selector switch (5, 10) comprises a single switch knob with a switch for selecting front or back seat window operation and, when pressed, disabling window operation.

5. A multiple switch device as described in claim 1, wherein:
said selector switch (5) comprises a rotary switch for selecting two contact positions (5a, 5b) for selecting a front seat and back seat position, and
a push-button switch for disabling window operation.

6. A multiple switch device as described in claim 1, wherein:
said selector switch (10, 22, 37) comprises a switch movable in two directions for selecting front window operation or rear window operation, and
a switch for disabling window operation.

7. A multiple switch device for operating a power window and having a window operating switch (30a, 30b) for raising and lowering a vehicle window, and a selector switch (22) for selecting a window to be operated by window operating switch (30a, 30b), wherein:
the selector switch (22) combines functions of a rocker switch for moving a knob (22l) in two directions to select operation of a front seat window or rear seat window, and
a push-lock switch for disabling and enabling window operation when the knob (22l) is pressed.

8. A multiple switch device as described in claim 7, wherein the selector switch (22) is in a contact position (22c) for operating a front seat window when the knob (22l) of selector switch (22) is in an upright position, and is in a contact position (22d) for operating a back seat window when the knob (22l) of selector switch (22) is rocked.

9. A multiple switch device for operating automobile power windows in a first row, second row, and third row, comprising:
first to fourth window operating switches (39, 40, 41, 42) for operating first row, second row, and third row power windows; and
a selector switch (37) for selecting whether the third and fourth window operating switches (41, 42) operate the power windows of the second row or third row.

10. A multiple switch device as described in claim 9, wherein:
the selector switch (37) combines functions of a rocker switch for moving in two directions to select operation of a second row window or a third row window, and
a push-lock switch for disabling and enabling window operation.

11. A multiple switch device as described in claim 10, wherein the selector switch (37) is in a contact position (37b) for operating a second row window when the knob (37a) of selector switch (37) is in an upright position, and is in a contact position (37c) for operating a third row window when the knob (37a) is rocked.

12. A multiple switch device comprising:
a knob (22l) having protruding from the bottom thereof an operating lever (22f) for operating a switch unit (27), and a single operating part (22e) enabling push-action and rocker-action operations;
a rocker body (24) movably supported to case (21) on a pivot with operating lever (22f) of knob (22l) passing freely up and down therethrough;
a case (21) having a through-hole (21i) for operating lever (22f) passing therethrough; and
a plurality of switch units (27c, 27d) operated by movement of first and second sliding studs (27a, 27b), which engage a shaped slot (22h) formed in the operating lever (22f) of the knob (22l).

13. A multiple switch device as described in claim 12, wherein:
the knob (22l) has a cam (22g) on a side of operating lever (22f);
the rocker body (24) has a lock pin (26) for engaging the cam (22g) and a leaf spring (25) for urging the lock pin (26), and forms a suitable surface (24g, 24h) contacted by a suitable body (28), which is urged by suitable spring (29); and
the case (21) has a positioning part (21a) for placing the knob (22l); and
the through-hole (21i), a tubular protrusion forming a blind hole (21h) for holding the suitable spring (29), and stud hole (21g) for pivotably supporting the rocker body (24) are formed inside the positioning part (21a).

14. A multiple switch device as described in claim 12 or 13, wherein:
the shaped slot (22h) formed in the operating lever (22f) has a longitudinal slot (22i) in which the first sliding stud (27a) floats when the knob (22l) is pressed,
a sloped slot (22j), contiguous to the longitudinal slot (22i), for pushing and moving the second sliding stud (27b) when the knob (22l) is pressed, and
an escape slot (22m) in which second sliding stud (27b) moves freely when the knob (22l) is rocked.

15. A multiple switch device comprising:
a switch (30a, 30b, 41, 42) having protruding from a bottom thereof an operating lever (30d) for operating switch units (34, 35), and a rocking knob (30f); and
a movable selector (33) disposed to the operating lever (30d) of the switch (30a, 30b, 41, 42) for operating the two switch units (34, 35);
one switch unit (34) being operated by movement of a sliding stud (34a, 34b), which engages a first notch (33b) formed in the movable selector (33), and
an other switch unit (35) being operated by movement of a sliding stud (35a, 35b), which engages a second notch (33c) formed in the movable selector (33).
